(19) United States
(12) Patent Application Publication
(10) Pub. No.: US 2010/0178028 A1
(43) Pub. Date: Jul. 15, 2010

(54) INTERACTIVE GAME

(76) Inventors: Adi Wahrhaftig, Toronto (CA); Benny Pesach, Rosh-ha'ayin (IL)

Correspondence Address: Heenan Blaikie LLP;Bay Adelaide Centre, 333 Bay Street, Suite 2900, P.0. Box 2900, Toronto, ON, M5H 2T4, CA

(21) Appl. No.: 12/532,947

(22) PCT Filed: Mar. 24, 2008
(86) PCT No.: PCT/IL2008/000405

§ 371 Date: Mar. 10, 2010

Related U.S. Application Data
(60) Provisional application No. 60/896,898, filed on Mar. 24, 2007.

(51) Int. Cl. H04N 5/91

(52) U.S. Cl. 386/70; 386/E05.003

(57) ABSTRACT

An interactive audiovisual musical game that includes a television set, a DVD player, a DVD player remote control, and a DVD disk, wherein the DVD player executes a program recorded on the DVD disk such that the DVD disk responds to pressing a given key on the remote control by producing a given audio stream through the television set audio system and displaying a given image on the television display.

### FIELD OF THE INVENTION

The present invention is of an interactive audiovisual musical game that is played through the interaction of a DVD player, a DVD player remote control and a DVD disk, and in particular of such a game wherein the DVD player executes a flow recorded on the DVD disk such that the executed flow causes the DVD player and/or associated television to react to one or more signals from the remote control, according to pressing one or more keys on the keypad, for example.

### BACKGROUND OF THE INVENTION

Many children, as well as adults, like to play music. However, real musical instruments with high quality sound are in many cases expensive and require years of training to use. A common, low cost alternative currently available is toys simulating real instruments, such as organs, pianos, saxophones, and guitars. However, most of the toys simulating musical instruments produce very low quality sound.

For example, computer games are known in the art for providing sound. These games require additional equipment beyond a DVD player, remote and television set, which can be very expensive.

U.S. Pat. No. 7,003,598 teaches that a special device, in combination with a DVD player and television set, may be used to produce music. However, the special device is intended only for this purpose and is not part of the typical home entertainment equipment that is available in many households. Similarly, U.S. Pat. No. 6,565,440 teaches such a dedicated device, in the form of a special remote control.

On the other hand, many houses are equipped with entertainment systems, including DVD players, set top boxes, television sets, sound systems, etc. that are currently used for playing movies and music.

### SUMMARY OF THE INVENTION

The background art does not teach or suggest a device, system and method for interactive music applications by using a DVD player and a standard remote control, without requiring additional or specialized devices.

The present invention overcomes these drawbacks of the background art by providing a system, device and method for music applications in which the program instructions are provided on the DVD itself, such that a standard DVD player and remote control may optionally be used.

As used herein, the term “DVD player” may optionally relate to any device capable of least audio playback from a DVD disc, but which is preferably also capable of video playback. The DVD player preferably causes a peripheral device, such as a television set and/or audio system, to play back the video and/or audio data. The present invention may optionally be implemented in a DVD player or alternatively may optionally be incorporated in another device, including without limitation a set top box or game console (including but not limited to Sony Play Station, MS XBOX or Nintando Wii).

The remote control preferably is able to control at least the DVD player, whether as a stand-alone device or as an embedded device. The remote control is preferably a standard remote control as defined by the DVD specifications; preferably the remote control communicates with the DVD player wirelessly, for example through optical communication, infrared (IR) or RF (radiofrequency) signals. Optionally and alternatively, the remote control may feature one or more additional functions, such as one or more special buttons or keys for example, for playing music, and may also optionally be in the shape or configuration of a music instrument, such as an organ, piano, guitar, drums and the like.

The DVD disc preferably includes a plurality of instructions for defining the association of the signals received from different keys of the remote control to different audio streams and/or video streams and/or discrete sounds and/or discrete images, enabling the user to play different tunes and images on the television set using the remote control keys. The DVD disc also preferably includes structured DVD data such as menus, navigation links and so forth.

In some embodiments, the interactive audiovisual musical game is a melody track game.

In some embodiments the program produces a given audio stream out of a set of at least four audio streams and shows a matching image out of a set of at least four images, wherein the player should press one button out of at least four buttons related to a produced audio sound, then the program produces at least two given audio sounds out of a set of at least four audio sounds and shows a matching animation out of a set of at least four animations; then the player should press the sequence of at least two related buttons related to a produced audio sound; and this process preferably repeats itself with an increasing number of audio sounds until the player presses a wrong button on the remote control.

In some interactive audiovisual musical games the user needs to memorize tunes and play each one of them in certain situations of the game. The user scores points for determining the correct tune and the correct playing of the tune (ie the correct sequence of buttons pressed on the remote control).

In some interactive audiovisual musical games the program plays tunes and the user obtains points or a higher score by identifying the played note/s.

In some interactive audiovisual musical games the program plays tunes and the user obtains points or a higher score by identifying the correct accompanying chord.

In some interactive audiovisual musical games the program allows the user to try creating music which may then optionally be recorded and/or otherwise saved, thereby enabling users to compose their own tunes using built in rhythms, sounds, accompanying chords and patterns. The user optionally obtains points or a higher score for more complex and longer melodies.

In some interactive audiovisual musical games a camera such as in the Sony PS Eye Toy is used and the user can play on a virtual musical instrument, which is displayed on the screen. The virtual musical instrument can be one of many such as drum set. The virtual musical instrument can be operated by moving the hand as if playing on the virtual musical instrument and the camera identify those movements and response as if the player was playing the simulated instrument.

In some interactive audiovisual musical games the program plays a song and the user can disable (put on mute) one of the musical instruments sounds such as the drum set and on the TV the visual display will show the user what he need to do in order to play the missing part. Visual signals like lights or markers can show him when he needs to hit each drum of the set. The user may enable the musical instrument sounds to hear the original sound and can play along with it this game can let players practice in different levels of complexity and each song in different speeds/tempo. In this game the user can choose practice mode and when ready performance mode.

As described herein, the term “remote control” refers to a standard remote control device for a DVD player without any additional functionality unless otherwise described. For embodiments featuring additional functionality, preferably computations and execution of instructions for performing the musical application, for example for playing the game, are performed by the DVD player and not by the remote control device itself.

According to some embodiments, there is provided an interactive musical system comprising: a display unit (which may optionally be a television set for example); a DVD player connected to the display unit; a DVD player remote control for receiving one or more user input commands and for transmitting the one or more commands to the DVD player; and a DVD disk for comprising a plurality of audible sounds, wherein the one or more user commands causes the DVD player to play the one or more audible sounds from the DVD disc.

Optionally, each audible sound is selected from the group consisting of an audio stream, a song, a single discrete audible sound, a plurality of discrete audible sounds and one or more audible chords. Preferably, the audible sounds simulate a musical instrument. Alternatively, the audible sounds simulate animal sounds.

Optionally, the DVD player further comprises a DVD VM (virtual machine) and wherein the one or more user commands are interpreted by the DVD VM for playing back the one or more audible sounds. Preferably, the DVD disc further comprises one or more instructions for being executed according to the one or more commands by the DVD VM.

Optionally, the DVD disc further comprises at least one visual data selected from the group consisting of an image, video data, animation and a video stream, and wherein the one or more commands causes the visual data to be displayed by the television set. Preferably, the displayed image is an image of note symbols shown on horizontal lines and wherein the audible sounds simulate one or more musical instruments. More preferably, the note symbols represent the notes of a known song.

Optionally, the remote control is shaped like a musical instrument. Preferably, the remote control is shaped like an organ keypad, or like a drum machine or like a guitar.

Optionally, the remote control can send a predetermined sequence of control signals in response to pressing at least one button.

According to other embodiments, there is provided method for an interactive musical application with a DVD player and a DVD remote controller, comprising: Operating a DVD disc by the DVD player, the DVD disc comprising a plurality of audible sounds, a plurality of visual data and a plurality of instructions; Entering one or more commands through the DVD remote controller by a user; and Selectively playing back one or more of the audible sounds and/or of the plurality of visual data by the DVD player according to the one or more commands, comprising executing one or more of the instructions by the DVD player.

Optionally, each audible sound is selected from the group consisting of an audio stream, a song, a single discrete audible sound, a plurality of discrete audible sounds and one or more audible chords. Optionally, the audible sounds simulate a musical instrument. Optionally, the audible sounds simulate a sound selected from the group consisting of animal sounds, vehicle sounds, natural sounds, sound effects, synthesized sounds, digitized voices and mechanical sounds.

Optionally, the visual data is selected from the group consisting of an image, video data, animation and a video stream.

Optionally, the DVD player further comprises a DVD VM (virtual machine) for executing the one or more instructions and wherein the one or more user commands are interpreted by the DVD VM for playing back the one or more audible sounds. Preferably, the selectively playing back one or more of the audible sounds and/or of the plurality of visual data comprises analyzing at least one user command by the DVD VM; selecting a location on the DVD disc; and playing back data at the DVD disc.

Optionally, the method further comprises displaying at least the visual data through a television set. Optionally, the displaying comprises displaying an image of note symbols shown on horizontal lines and wherein the audible sounds simulate one or more musical instruments.

Optionally, the note symbols represent the notes of a known song, the method further comprising pressing keys on the DVD remote controller according to the image of one or more symbols displayed on the television set.

Optionally, the image comprises a plurality of symbols in a defined sequence and the pressing the keys comprising pressing the keys in a defined sequence corresponding to the defined sequence of the symbols.

Optionally, the method further comprises highlighting a symbol corresponding to a key to be pressed next by the user.

Optionally, the plurality of notes corresponds to a known song.

Optionally, the plurality of notes is a random sequence.

Optionally, the method further comprises playing back an audio stream selected from a plurality of audio streams; Displaying an image related to the audio stream being played back included in a plurality of images; and Pressing a key by the user to select the image corresponding to the audio stream.

Optionally, the method further comprises Entering a plurality of commands by the user through the DVD remote controller to determine a sequence of audible sounds and/or visual data.

Optionally, the method further comprises storing the sequence.

Optionally, the method further comprises playing back the sequence.

Optionally, the method further comprises repeating the entering one or more commands and the playing back at least one or more sounds to play a melody tracking game.

Optionally, the method further comprises Producing a given audio stream out of a set of at least four audio streams and showing a matching image out of a set of at least four images, pressing at least one button out of at least four buttons related to a produced audio sound by the user; repeating the producing and the pressing with an increasing number of audio sounds and button pressings until the user presses an incorrect button on the remote control.

Optionally, the producing comprises producing a given audio sound out of a set of at least six audio sounds and showing a matching animation out of a set of at least six animations.

Optionally, the producing comprises producing a given audio sound out of a set of at least eight audio sounds and showing a matching animation out of a set of at least eight animations.

Optionally, the DVD player is connected to a television set. Optionally, the purpose of the interactive musical application is music education. Optionally, the images are short video clips. Optionally the audio streams are notes played by a musical instrument. Optionally, the purpose of the interactive musical application is music education.

Optionally, the purpose of the interactive musical application is a game.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

### BRIEF DESCRIPTION OF THE FIGURES

These and other features and advantages of the present invention will become more apparent from the following detailed description of an exemplary embodiment thereof, as illustrated in the accompanying drawings, in which:

FIG. 1 shows an exemplary illustrative system according to the present invention;

FIG. 2 shows a flowchart of an exemplary, illustrative method according to the present invention;

FIG. 3 is a simplified diagram of optional menu structures for a suggested DVD data structure according to the present invention;

FIG. 4 is a flowchart of an exemplary, illustrative method for a song learning game according to the present invention;

FIG. 5 is an example of a possible image of symbols to be displayed in the song learning game of FIG. 4;

FIG. 6 is another example of a possible image of notes to be displayed in the song learning game of FIG. 4;

FIG. 7 is a flowchart of an exemplary, illustrative method for a note playback game according to the present invention;

FIG. 8 is an illustration of standard remote control keys;

FIG. 9 is an example of a possible image or animation to be displayed in a melody tracking game;

FIG. 10 is an example of a possible image or animation to be displayed in a melody tracking game; and

FIG. 11 is an example of a possible image or animation to be displayed in a melody tracking game.

### DESCRIPTION OF PREFERRED EMBODIMENTS

The present invention is of a system, device and method for music applications in which the program instructions are provided on the DVD itself, such that a standard DVD player and remote control may optionally be used. The present invention enables a musical instrument to be simulated according to input commands from the remote control (remote control or remote control device). DVD players are capable of choosing and playing pre-stored audiovisual content in response to a set of keys pressed on the DVD remote control. According to some embodiments, the present invention employs this characteristic to create a musical game in which various musical instruments are simulated using the DVD remote control.

According to some embodiments of the present invention, implementation is performed with a virtual machine implemented by the DVD player, which runs byte code contained on the DVD. This virtual machine is provided on all standard DVD players and is used to control playback and display special effects on the menus. The instruction set is called the Virtual Machine (VM) DVD command set. There are 16 general parameter registers (GPRM) to hold temporary values and 24 system parameters (SPRM), for a total of 36 parameters. The DVD VM enables the program code, containing the plurality of program instructions, to be executed according to one or more input commands received from the remote control.

For example link instructions may be used to move from one video segment to another within the same domain. These commands may also optionally be conditional, such that the command is only executed after a comparison function is performed. Jump and call instructions may optionally be used to move within domains.

Within a particular domain, the DVD data structure provides for data to be divided into one or more video title sets; each video title set corresponds to a single program. For the purpose of the present invention, each video title set may optionally correspond to a particular application or game as described herein. Within each video title set there are a plurality of video object sets, each of which in turn comprises a plurality of video objects. The video objects in turn are divided into a plurality of cells. Each cell comprises plurality of data unit types, such as video, audio, subpicture, etc, and corresponds to a program segment.

The above data types are in turn accessible according to a presentation structure, which enables different portions of the data to be potentially accessible according to one or more commands from the remote control. The presentation sequence is defined by programs (PGs), each of which comprises a linked list of pointers to cells. A plurality of PGs may be combined to form a program chain information (PGCI), a plurality of which may in turn be combined to form program chain (PGC) as described above. The presentation structure is typically used to enable one or more menus to be constructed, so that the user can navigate within the DVD disc. However, such navigation is used by the present invention to cause music to be played back as constructed from the input commands of the user and the data on the DVD disc.

As described in greater detail below, the remote control is operated by user to input a sequence of one or more pressed button inputs. This sequence is then analyzed by the DVD VM, according to the provided instructions on the DVD disc, to determine the output response. For example, the output response may optionally include playing back a series of audible sounds (for example specific musical notes) and/or providing one or more images, according to playing back of such data from different locations on the DVD disc. The inputs from the remote preferably invoke various instructions on the DVD disc, which are interpreted as link instructions and so forth, as described in greater detail below, thereby causing data playback from the different locations on the disc.

Further details regarding the DVD data structure and presentation structure may be found in U.S. Pat. No. 7,076,149, hereby incorporated by reference as if fully set forth herein.

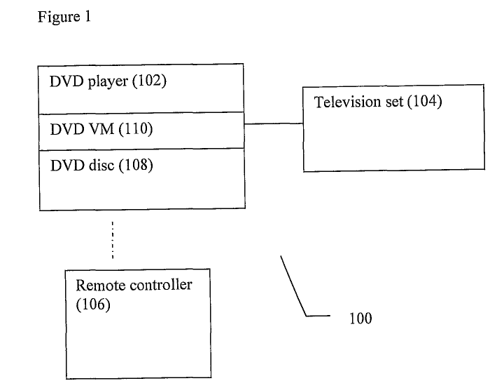

Turning now to the drawings, FIG. 1 shows an exemplary system according to the present invention for a musical application. As shown, a system 100 includes a DVD player 102, a television set 104, a remote control 106 and a DVD disc 108. Remote control 106 features a transmitter (not shown) for communicating with a receiver (not shown) of DVD player 102, for example according to IR (infrared) signals (the connection is shown with a dashed line to indicate that it is preferably wireless). Such communication is well known in the art. Remote control 106 features a plurality of buttons; as a button is pressed by the user (not shown), a signal is sent from remote control 106 to DVD player 102, indicating the button pressed. DVD player 102 then performs an action, for example with regard to DVD disc 108, according to the input command from the pressed button.

DVD player 102 also features a DVD VM 110 for interpreting data and also one or more commands on DVD disc 108 according to one or more commands received from remote control 106. As is known in the art, input commands from the pressed buttons preferably cause DVD VM 110 to perform one or more actions on DVD disc 108, such as reading data from different portions of DVD disc 108. The read data is then preferably displayed, for example through television set 104 and optionally (for audio data) additionally or alternatively through an audio player (not shown), which may be separate from or combined with television set 104.

For the purpose of the present invention, the input commands from the pressed buttons are used to cause different audio and/or video data to be played from DVD disc 108, thereby simulating musical sounds (for example). The sequence of buttons may optionally correspond to a sequence of musical notes (discrete audio sounds) provided at different locations on DVD disc 108; alternatively or additionally, the sequence of buttons may optionally correspond to one or more audio streams. Similarly, discrete images and/or video streams may optionally be provided according to the input commands from remote control 106.

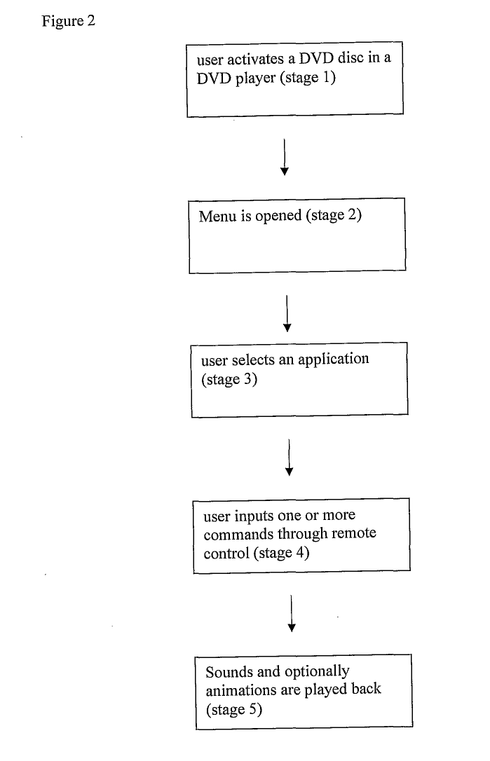

FIG. 2 is a flowchart of an exemplary, illustrative method according to the present invention for implementing a musical application. In stage 1, the user activates a DVD disc in a DVD player. In stage 2, a menu is optionally and preferably opened which provides a plurality of different musical applications and is displayed to the user, as described in greater detail below, optionally after some introductory audiovisual content. In stage 3, the user selects an application, for example to play a plurality of discrete audible sounds, a combination of such sounds, audio streams and so forth.

In stage 4, the user inputs one or more commands to select particular sounds through the remote control. As the commands are provided to the DVD player, one or more discrete sounds are played back according to one or more instructions and/or data on the DVD disc, as interpreted according to the DVD VM as previously described, in stage 5. Optionally a video display may be provided as well, showing the selected audible sounds according to standard musical notation, for example.

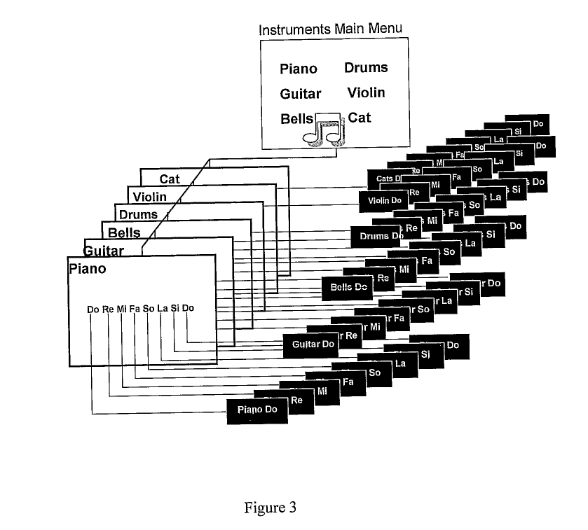

FIG. 3 shows an exemplary menu in more detail. In this menu, the player can choose what musical instrument he would like to play. After he chooses a musical instrument, the DVD player preferably causes a submenu specific to the chosen musical instrument to be displayed. It should be noted that in this document, in addition to the known musical instruments, the expression ‘musical instruments’ also includes virtual musical instruments with a virtual shape or a virtual sound or both, such as computer generated sounds. In the musical instrument submenu, some audiovisual content related to the musical instrument may optionally first be displayed. Then the player can actually play that simulated instrument by pressing specific keys on the remote control, such as the 0-9 number keys. Each key activates a virtual button or a virtual machine code on the menu that produces the sound of a different note of the musical instrument, as illustrated in FIG. 3, as previously described.

In addition, the DVD player may optionally cause a given visual content or animation related to that note to be displayed, for example on the accompanying television set. For example, if the player chooses the piano as a musical instrument, the piano submenu can show an image of a piano. Each key pressed on the remote control may, for example, activate one piano note from the known “Do, Re, Mi, Fa, So, La, Si” sequence of a given octave or even sub-notes like Fa # or Si b and will further show an animation of a piano with that note key being pressed. In this way, the player will see the real piano keys being pressed and will enjoy the high quality sound supported by the DVD player, television set, and the sound system, which is usually of high quality, unlike the sound quality of musical instrument toys.

Optionally, the virtual instruments can also include animal sounds of, for example, a cat, a dog, a cow, and a frog. The tone of those animals mewing, barking, mooing, and croaking may be reproduced by computerized, known in the art means to fit the different required musical tones and may be recorded on the DVD. Accordingly, when the player chooses, for example, a cow, the DVD player goes to the cow submenu, in which some audiovisual content related to a cow may be shown. Then, at the cow submenu, when an appropriate key on the remote control is pressed, the relevant “moo” sound may be played with, for example, a related short animation.

Other non-limiting examples of such noises include sounds from vehicles, thunderbirds, winds, rain, waves, fire (as examples of natural sounds), mechanical sounds, synthetic sounds, robotic sounds, digitized voice sounds and the like.

Optionally, instead of using the standard remote control of the DVD, a special remote control shaped like, for example, an organ keypad or another musical instrument, may be supplied together with the musical application DVD disc. The special remote control is preferably able to communicate with or to control all major models of DVD players on the market. Similar products for universal IR remote control are well known in the art and in addition to controlling the major DVD players, they also control major models of television sets, VCRs, set top boxes and sound systems. Usually, in these cases, a specific code should be entered into the special remote control according to the DVD player model. To enable entering the DVD player model code, preferably some of keys on the musical instrument-shaped special remote control have the numbers 0-9 related to or printed in the vicinity of the keys.

Optionally, the musical instrument-shaped special remote control has non-volatile memory, as is known in the art for universal remote controls, in which case this code is preferably entered once for use with a specific DVD player model. Another known in the art method that can be used for adapting universal remote controls to a specific DVD player is by the reading of the specific DVD player remote control IR signal for the needed operations by the universal remote control and optionally saving one or more those signals at a memory element.

The musical instrument-shaped special remote control preferably also includes arrow keys or other required keys to enable navigation through the various menus of the DVD player in order to arrive at the required musical instrument menu. Once at that menu, each relevant key of the musical instrument-shaped special remote control will reproduce the high quality sound tone that the corresponding key on the original instrument would produce. It should be noted again that currently, most of the toys simulating musical instruments have very poor sound quality. An example of a widespread toy is an organ. The advantage of the present invention can be demonstrated such that by integrating a low cost organ that acts as the DVD player IR special remote control, the user gets at low cost instrument with high quality sounds provided by the higher quality DVD media (disc) home entertainment sound system and speakers.

Optionally, at least one button of a special remote control can simulate a sequence of keys pressed on a standard remote control. This simulation can be implemented easily by adding a simple code to the special remote control controller. An example of such a simulation is sending a signal through the IR light emitting diode (LED) that simulates a first pressed key, then after a short delay, sending a signal simulating a second pressed key, and so on. For example, one button may generate the sequence 38 (the sequence of the 3 key and then the 8 key). Another example might be a special button that generates the sequence “->->->OK” (the right arrow key and the “OK” or “enter” key on the remote control), by sending signals simulating pressing the right arrow key “->” three times and then sending the signal simulating pressing the “OK” key. Optionally during the course of playing a game, the sequence that a button generates may be changed. For example, the first time a designated button is pressed, it may generate the sequence “->OK”, the second time may generate the sequence “->->OK”, and the third time may generate the sequence “->->->OK”.

Optionally one of the simulated instruments is a drums set. According to such an option, the remote control may simulate a drum system, such that each key produces the sound of the beat on a different kind of drum when pressed. Examples of drums include Bass, Snare, Crash Cymbal, Ride Cymbal, Open/Closed Hi-Hat, High Tom, Low Tom, Middle Tom, Cow Bell, and Side Stick. Optionally, an image or animation of the played drum may be shown.

Optionally, the simulated instruments may include percussion instruments. According to such an option, the remote control may simulate percussion instruments, such that each key produces a sound of a different kind of percussion instrument when pressed. Optionally, an image or animation of the played percussion instrument may be shown.

Optionally, the percussion instruments or drums may produce not the sound of a single hit but rather of longer rhythms, such as, for example, Drum Loops. According to such an option, one key may produce, for example, a samba rhythm; other keys may produce, for example, Disco, Trance, R and B, Tango, Polka, Bosa Nova, Rumba, Salsa, Country, Flamenco rhythms, etc. According to some embodiments, each rhythm might be in a different Tempo.

Optionally, the DVD may also include menus that enable the selection of a song or a melody, such that when each relevant key on the regular or special remote control is pressed, a different melody is selected out of a set of preset melodies presented in that menu. Each of the melodies or songs may also have a different image or video shown while the melody is played. This optional menu can be optionally accessed from a shared main menu that enables choosing the musical instruments menu or said melodies menu or other optional menus described in the present invention. The order and hierarchy of the menus can have many options, which are not described here in detail, but will be chosen according to user ease of use.

Optionally, the Melodies Menu enables choosing the instrument on which said melody will be played. Another option is that the Melodies Menu will be under the Musical Instruments Menu, such that after a specific instrument is chosen, in addition to playing notes, the user can choose to play a set of the same or different melodies along with that instrument.

Optionally, the DVD also includes a menu that enables adding different instruments that are all playing the same melody. Optionally, each of the relevant buttons may activate a different number of instruments, all playing the same melody. For instance, pressing 1 may start the percussions, pressing 2 may add drums playing the same rhythm, pressing 3 may add the piano playing the same music piece, pressing 4 may add a violin, pressing 5 may add a trumpet, pressing 6 may add a human singer voice, pressing 7 may add accompanying singers, etc. In another suggested option, the user can choose any combination of a set of musical instruments playing the same music piece. These options are preferably provided through the use of audio streams which may be selected from different portions of the DVD disc as described herein and/or through the provision of discrete audio sounds which comprise a combination of a plurality of different sounds from different musical instruments, for example optionally pre-arranged into chords and the like.

Optionally the percussion instruments or drums may be selected or deselected, and according to the current selection, a drum loop or rhythm is produced. According to such an option, when selecting additional instruments, they too will be heard, and when deselecting an instrument, it will not be heard.

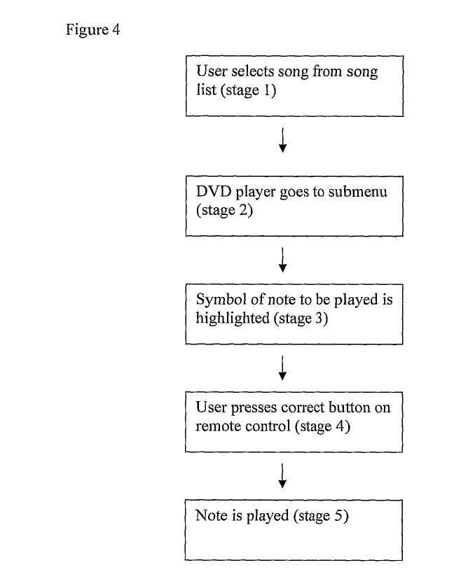

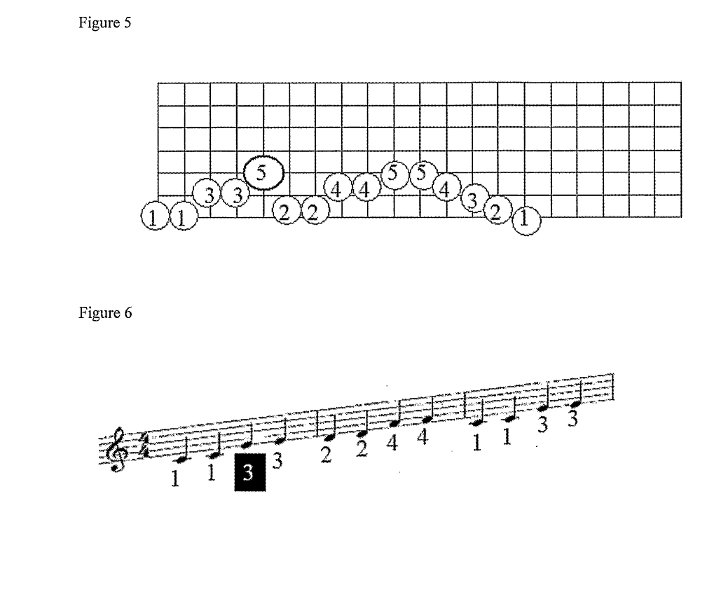

FIG. 4 relates to another optional embodiment of the present invention, as a flowchart showing an exemplary, illustrative method for an educational musical game. In stage 1, the user preferably selects a song from a list of songs which are optionally displayed on a Song Learning Menu. In stage 2, the DVD player goes to a submenu that causes a plurality of symbols representing the notes of the songs to be displayed. In addition, the DVD player may also optionally and preferably cause the display of images or video related to the chosen song. The symbols can be, for example, musical notes as shown in FIG. 5 or circles with numbers inside as shown in FIG. 6, which relate to remote control keys (for example number keys). In case of the notes shown in FIG. 5, the remote control button symbols are preferably shown underneath each note. In addition, different colors can be applied to different notes or symbols. Those colors also may be on the buttons of the musical instrument-shaped special remote control, to ease repeating the visual information of the song shown on the screen.

In stage 3, optionally, the symbol of the note that should be played at each moment is highlighted as shown by the circle in FIG. 5 or the rectangle on the number in FIG. 6. When the user presses the correct button on a standard remote control or on the musical instrument-shaped special remote control in stage 4, the correct note is played according to commands from the DVD player in stage 5. Optionally also animation, video or image data may be displayed to show that the symbol of that note was played. Afterward, the symbol of the next tone to be played may be highlighted to repeat stage 3, as shown in FIGS. 5 and 6, followed by the repetition of stages 4 and 5. This process may optionally continue, repeating stages 3-5, until the song ends. According to such an embodiment, the user is actually learning how to play a specific song.

If the user presses the incorrect key, several options are available. For example, one option involves the DVD player causing the playing back of the note that relates to the pressed key and indicating to the user that the user pressed a wrong key, by, for example, displaying the incorrectly pressed note with its proper symbol. Another option may involve playing the note that should have been pressed and indicating that a wrong key was pressed by some visual way. Yet another option is that the DVD player may cause the song playback process to start over from the beginning, again according to instructions on the DVD disc which are interpreted as previously described. Of course, other options which are not detailed here may also be included. Optionally the user can choose the instrument on which he is playing said song and the same regular or special remote control he is using will simulate that instrument.

Optionally, instead of playing the notes of a song, the user may play the chords that accompany the song or melody. According to such an option, the chords may be shown on the screen with or without the regular notes. Pressing the buttons of the regular or special remote control may generate musical chords, according to the shown chords. As before, the next chord to be played may be shown after each key is pressed.

Optionally, the user will be able to choose chords by pushing a few buttons on the standard remote control unit. For example, for each chord, a three-digit number may be assigned.

Another educational and fun option that also develops the musical memory and knowledge is that, as before, the user may choose a song from a menu with a list of songs. The DVD player may then cause the first note of that song to be played, optionally while displaying a symbol related to the key that should be pressed. Then, if the user presses the key correctly, the DVD player causes the first note to be played and displays the related key symbol and then causes the second note to be played and displays its related symbol. As the user presses the keys correctly, the game continues and more notes may be added until the full song is played.

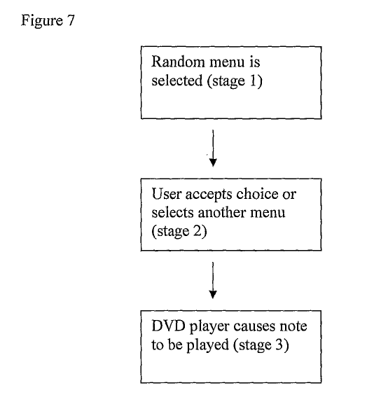

In a similar option according to some embodiments of the present invention, instead of using known songs, the DVD disc may optionally contain a random combination or sequence of notes that are played in the same manner, which is also termed herein a “song”. The DVD player chooses randomly a menu out of a set of, for example, a few dozen menus, each of which contains, for example, a different prerecorded random sequence (song) of at least four notes. The DVD player then causes the first note of the selected song to be played and displays a symbol or image or short video clip related to the key that should be pressed. Then, if the user presses the key correctly, the DVD player causes the first note to be played and displays the related key symbol or image or short video clip and then causes the second note to be played and displays its related symbol or image or short video clip. As the user presses the keys correctly, the game continues and more notes may be added until the full chosen prerecorded song is played. This option is described in greater detail with regard to FIG. 7 below.

According to another embodiment, as shown in FIG. 7, instead of using known songs, the DVD disc may optionally contain data related to a random combination of notes that are played in the same manner. According to such a game, the DVD player may optionally cause a menu to be randomly selected from a set of, for example, a few dozen menus, each of which contains, for example, a different prerecorded random song of at least four notes, in stage 1. The user may then optionally accept the choice or may request another menu in stage 2.

Upon acceptance of a particular menu by the user, the DVD player then preferably causes the first note of the chosen song to be played in stage 3, optionally while causing a symbol related to the key that should be pressed to be displayed. If the keys or buttons are correctly pressed, then the DVD player optionally causes the next group of notes to be displayed, again optionally according to a random selection, and so forth. Alternatively, the note symbol may optionally be displayed but the note is only played once the user has pressed the correct key corresponding to the correct note.

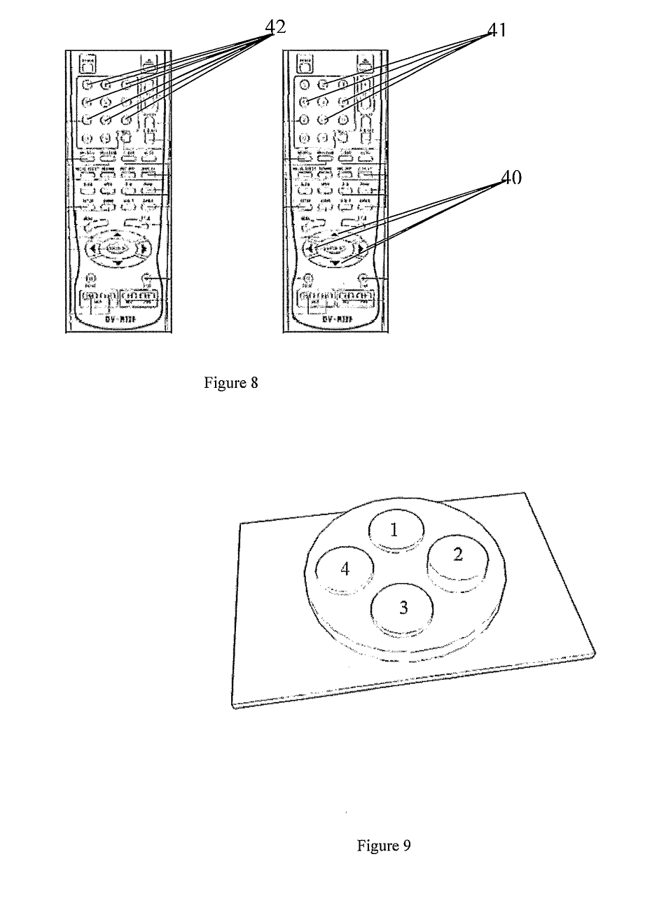

In the case of four notes, the keys may be, for example, the four arrows keys 40 on the standard remote control of a DVD player, as shown in FIG. 8. Alternatively, the four keys may be four other keys on the standard remote control, such as, for example, four numbers keys 41 for a four-note game, or eight number keys 42 arranged as a square if playing an eight-note game. On a special remote control, various numbers of keys may also be used according to the game level and the displayed image may correspond to the shape of said special remote control. In addition, on the special remote control, each symbol may have a different color.

An example of an optionally displayed image which corresponds to keys to be pressed, is shown in FIG. 9. In this image, the round buttons 1, 2, 3 and 4 are spatially arranged like the arrows keys 40 in FIG. 8 so that it will be easier for the user to understand which arrow key relates to which button on the image. Then, if the user presses the correct key on the remote control, the DVD player may optionally cause the first note to be played and display the related animation and then play the second note and display the related animation. Optionally, the related animation may show the related button at the remote control being pressed. If the user presses the keys correctly, the game continues on and on until the user fails. The DVD player may optionally store in one of its registers the highest score.

Optionally, the tracking game may be played in different levels of difficulty. When the user finishes successfully one level, he might, for example, see a movie for success, and then be able to continue to the next level, which will be harder by one or more of sequence, length, number of notes (4, 6, or 8), and other parameters. The movie for success may be chosen randomly from, for example, a set of movies for success. There may be different “worlds” for the game, wherein each world has its own scenario and look. For example, a world can be, inter alia, a children's playground or stars in space, or animals in the jungle, etc.

When reaching a new level, the user may go to different location in the “current world”, for example, going from one star to another in the space world.

Upon failure, the user may see, for example, a failure movie, which may be also chosen randomly out of a set of failure movies.

The games may also be played by a group of users and not only by one player. The users may, for example, select from the start menu the number of players. According to some embodiments, individual players take turns playing the game, according to a chosen order, for as many rounds as the players want. For each player a random song or note sequence may be chosen out of said set of a few dozen songs. The DVD player registers may be used to store the accumulated scores of each player and may display said scores after each single game.

Optionally in the melody track game, instead of a set of four single notes that are sequenced randomly in few dozen combinations prerecorded on the DVD, a set of more complex audio streams may be used. For instance, the at least four audio streams may be the voices of animals, such as a cat, a dog, a cow, and a frog. In addition, for each chosen animal an image or short animation movie of that animal may be displayed alone or in the background or to the side of the image of the relevant key that should be pressed on said remote control.

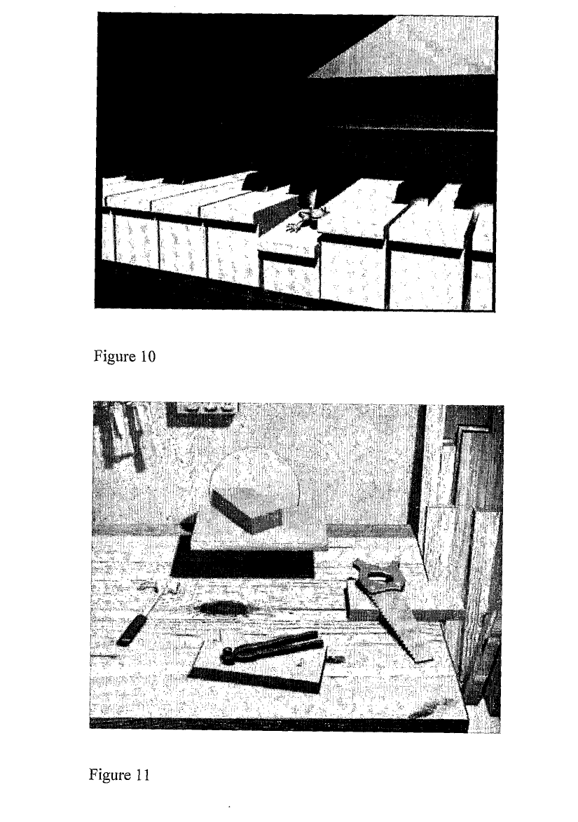

In FIG. 10, an image related to another example of implementing a melody track game is shown, wherein a melody is being played on a piano by a jumping frog. Each time the frog jumps on a piano key, another note is played. In this implementation, for each piano key in the range from “Do” to “Si”, a number on the remote control is been assigned; so, 1 is assigned to “Do”, for “Re” 2 is assigned, and so on. For each round, the user tries to repeat the sequence of notes that was played. If the user is successful and completes the sequence, another note will be added to the sequence and the game continues. If the user fails, the game starts all over again from the beginning with the same sequence or with another sequence that is, for example, chosen randomly.

Another example, shown in FIG. 11, is of an image related to a game featuring tools including hammers, saws, pincers, and files, each with its own audio sound and animation. According to some embodiments, the four tools can be arranged in the image similar to the four arrows keys, as shown in FIG. 11, such that it is clearer to the user what arrow key is related to which tool. Optionally, a smaller or larger set of audio streams and matched images or animations or both can be used according to the required level of difficulty.

Another system and application suggested by the present invention is to use a set top box such as a cable television set top box or a satellite television set top box as the media that executes the application instead of using the DVD and DVD player. According to such an option, the set top box with its standard remote control or musical instrument-shaped special remote control as described before simulates the musical instrument or provides the previously described interactive musical game options. According to such an option, again the high quality sound and visual effects of the television and the related sound system are kept. In addition, more options are available since the set top box devices can usually execute more complex software codes. When the user chooses to play an interactive game from the set top box menu displayed on the television set, usually a remote server downloads the required code through the cables or satellite communication to the set top box. Clearly, in this case the code is implemented in the proper software code that best fits to the said set top box processor. Then the user or users may play said games for their musical education or fun, as described before. According to such an option, the cable or satellite service providers may charge the user, for example, per use of a game or may add a fixed amount to the monthly subscription payment according to the game options that the user want to use in a given month.

Another system and application suggested by the present invention is to use a video game console such as Sony Play Station 2, Play Station 3, Microsoft's XBOX, Nintendo Wii, Sega, or Atari, as the device that executes the application instead of using regular DVD player. According to such an option, the video game console with its standard remote control or musical instrument-shaped special remote control as described before simulates the musical instrument or provides the previously described interactive musical game options. According to such an option, again the high quality sound and visual effects of the television and the related sound system are kept. In addition, more options are available since a video game console devices can usually execute more complex software codes and can support much more dynamic real-time software algorithms. When the user chooses to play an interactive game from the video game console menu displayed on the television set. Clearly, in this case the code is implemented in the proper software code that best fits to the said video game console. Then the user or users may play said games for their musical education or fun, as described before. Unlike other games such as Guitar Hero or Rock Band, the application suggested by the present invention offers serious musical educational training as well as having fun while playing.

In some embodiments the term remote control can be wider, such as in case of television game consoles, as the console game pads which are used for controlling the consoles operation may optionally be considered as a remote control.

The present invention suggests allowing free play of music, including options like setting tempo such as 70 BPM, 100 BPM, 140 BPM or any other, choosing rhythm such as Samba, Rumba, Tango, Soft Rock, Hard Rock, House, Trans, Reggae and many more, choosing the sound voice such as piano, guitar, violin, trumpet, human and many more including digitally sensitized voices. Many other options such as sound effects may be applicable as well as other features such as choosing accompanying chords. The games may be based on many possibilities such as identifying the chords or playing correctly songs in different levels of difficulty according to visual signals such as notes, keyboard letters or numbers. The game may include low tone and high tone playing, load or quiet playing, learning and playing special tune in certain situations of the game. It can also be combined with other games like basketball NBA, keyboard remote control may let the players play the tunes like in real life NBA basketball game. As mentioned before players will be able to experience free play of music and create their own melodies and tunes like with regular musical instruments. Players maybe able to edit the music they created and might print it using printer device as standard Notes and chords sheets.

Optionally, the musical instrument-shaped special remote control according to some embodiments of the present invention may be used both for DVD player interactive games or set top box interactive games. This option can be easily supported by the current known in the art technology of universal remote controls.

The set top box may also add background music or rhythm to the audio streams that are played by the user in the optional games described above. The set top box can run more complex application exploiting the set top box API, which is highly flexible and includes many options such as, inter alia, downloading from a central server, or uploading data via an Internet access. The data for uploading may include, for example, a saved musical piece the user just played and recorded.

The system and method of the present invention may optionally be combined with a media center; in this way, all the features available for the DVD will be applied and in addition, more options and flexibility will be available since a complete computer is devoted to serve entertainment needs.

While the invention has been described with respect to a limited number of embodiments, it will be appreciated that many variations, modifications and other applications of the invention may be made.

1-45. (canceled)

46. An interactive musical system comprising:
a display unit;
a DVD player connected to said display unit;
a DVD player remote control for receiving one or more user input commands and for transmitting said one or more commands to said DVD player; and
a DVD disk for comprising a plurality of audible sounds, wherein said one or more user commands causes said DVD player to play said one or more audible sounds from said DVD disc.

47. A system as in claim 46, wherein the purpose of said interactive musical application is music education.

48. A system as in claim 47, wherein said audible sounds simulate a sound selected from the group consisting of animal sounds, vehicle sounds, natural sounds, sound effects, synthesized sounds, digitized voices, mechanical sounds and musical instruments.

49. A system as in claim 48, wherein said remote control is shaped like a shape selected from the group consisting of a musical instrument, an organ keypad, a drum machine, or a guitar.

50. A system as in claim 49, wherein said remote control has more buttons than standard DVD remote control.

51. A system as in claims 49, wherein said remote control can send a predetermined sequence of standard DVD commands in response to pressing one button.

52. A method for an interactive musical application with a DVD player and a DVD remote controller, comprising:
Operating a DVD disc by said DVD player, said DVD disc comprising a plurality of audible sounds, a plurality of visual data and a plurality of instructions;
Entering one or more commands through the DVD remote controller by a user; and
Selectively playing back one or more of said audible sounds and/or of said plurality of visual data by said DVD player according to said one or more commands, comprising executing one or more of said instructions by said DVD player.

53. A method for an interactive musical application as in claim 52, wherein said audible sounds simulate a sound selected from the group consisting of animal sounds, vehicle sounds, natural sounds, sound effects, synthesized sounds, digitized voices, mechanical sounds and musical instruments.

54. A method as in claim 52, wherein the purpose of said interactive musical application is music education.

55. A method as in claim 54, wherein said remote control is shaped like a shape selected from the group consisting of a musical instrument, an organ keypad, a drum machine or a guitar.

56. A method as in claim 55, wherein said remote control has more buttons than standard DVD remote control.

57. A method as in claim 55, wherein said remote control can send a predetermined sequence of standard DVD commands in response to pressing one button.

58. A method as in 55, wherein said DVD player further comprises a DVD VM (virtual machine) for executing said one or sequence of instructions which were sent from the remote control as response to one user commands and interpreted by said DVD VM for playing back said one or more audible sounds and animations.

59. A method as in claim 53, wherein notes presented represent a known song, said method further comprising pressing keys on said DVD remote controller according to said image of one or more symbols displayed on said television set.

60. A method as in claim 59, wherein said image comprises a plurality of symbols in a defined sequence and pressing said keys comprising pressing said keys in a defined sequence corresponding to said defined sequence of said symbols.

61. A method as in claim 60, wherein said plurality of symbols is plurality of notes corresponds to one of a known song and a random sequence.

62. A method as in claim 54, further comprising repeating said entering one or more commands and said playing back at least one or more sounds to play a melody tracking game.

63. A method as in claim 62, further comprising:
Producing a given audio stream out of a set of at least four audio streams and showing a matching video stream out of a set of at least four video streams,
pressing at least one button out of at least four buttons related to a produced audio sound by the user;
repeating said producing and pressing with an increasing number of audio sounds and button pressings until the user presses an incorrect button on the remote control.

64. A method as in claim 63, wherein said audio streams are notes played by a musical instrument.
